(19) United States
(12) Patent Application Publication
(10) Pub. No.: US 2017/0150361 A1
(43) Pub. Date: May 25, 2017

(54) SECURE VEHICLE NETWORK ARCHITECTURE

(71) Applicant: Faraday&Future Inc., Gardena, CA (US)

(72) Inventors: Anil PARYANI, Cerritos, CA (US); Daniel L. KOWALEWSKI, Redondo Beach, CA (US); Jana Mahen FERNANDO, Torrance, CA (US); Eric Ryan EVENCHICK, Toronto (CA)

(21) Appl. No.: 15/356,422

(22) Filed: Nov. 18, 2016

Related U.S. Application Data
(60) Provisional application No. 62/258,348, filed on Nov. 20, 2015.

(51) Int. Cl. H04W 12/08; H04W 8/00; H04W 12/02

(52) U.S. Cl. CPC H04W 12/08; H04W 12/02; H04W 8/005; H04L 2012/40215

(57) ABSTRACT

Embodiments of the disclosure can provide for secure communication in a vehicle network by distinguishing among communications at different layers of the vehicle network and using different security levels depending on the network layer. For example, a communication between different electronic control units (ECUs) in the same domain (e.g., two ECUs in the powertrain domain) may not need as much as security as a communication that originates from an ECU in a different domain (e.g., the chassis domain) or from a device outside the vehicle. This can allow for increased security where compromise is a greater possibility, such as when communications originate from outside the vehicle, and decreased security where comprise is a lesser possibility and performance is a greater concern, such as communications between ECUs within the vehicle and/or in the same domain.

### CROSS REFERENCE TO RELATED APPLICATION

This application claims the benefit of U.S. Provisional Patent Application No. 62/258,348, filed on Nov. 20, 2015, the entire disclosures of which are incorporated herein by reference for all intended purposes.

### FIELD OF THE DISCLOSURE

This relates generally to data communication with electronic control units of a vehicle, such as an automobile.

### BACKGROUND

Modern vehicles, especially automobiles, increasingly include connected features that allow the vehicle to communicate with other devices, often over the internet. For example, a smartphone can be used to lock and unlock car doors, and thus security becomes an issue for any connected vehicle. However, security protocols such as encryption can be time-consuming and system intensive, thus making it impractical for vehicle systems that need to communicate with each other in real time.

### SUMMARY OF THE INVENTION

Embodiments of the present invention provide secure communication in a vehicle network by distinguishing communications at different layers of the vehicle network, and using different security levels depending on the network layer. For example, a communication between different electronic control units (ECUs) in the same domain (e.g., two ECUs in the powertrain domain) may not need as much as security as a communication that originates from an ECU in a different domain (e.g., the chassis domain) or from a device outside the vehicle. The present invention provides the advantage of providing increased security where compromise is a greater possibility, such as when communications originate from outside the vehicle, and decreased security where comprise is a lesser possibility and performance is a greater concern, such as communications between ECUs within the vehicle and/or in the same domain.

### BRIEF DESCRIPTION OF THE DRAWINGS

FIG. 1 illustrates an exemplary system for secure communication in a vehicle network according to embodiments of the disclosure.

FIGS. 2A-2B illustrate exemplary methods of secure communication in a vehicle network according to embodiments of the disclosure.

FIG. 3 illustrates an exemplary system for secure communication in a vehicle network according to embodiments of the disclosure.

### DETAILED DESCRIPTION

In the following description of embodiments, reference is made to the accompanying drawings which form a part hereof, and in which it is shown by way of illustration specific embodiments which can be practiced. It is to be understood that other embodiments can be used and structural changes can be made without departing from the scope of the disclosed embodiments.

Modern vehicles, especially automobiles, increasingly include connected features that allow the vehicle to communicate with other devices, often over the internet. For example, a smartphone can be used to lock and unlock car doors, and thus security becomes an issue for any connected vehicle. However, security protocols such as encryption can be time-consuming and system intensive, thus making it impractical for vehicle systems that need to communicate with each other in real time.

Embodiments of the present invention provides for secure communication in a vehicle network by distinguishing amongst communications at different layers of the vehicle network and using different security levels depending on the network layer.

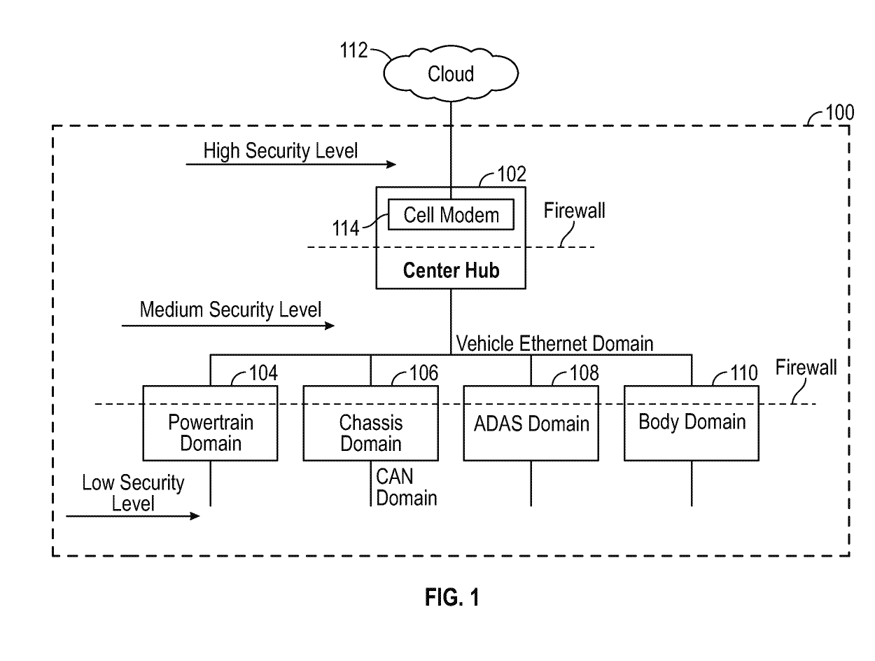

Although examples of the present invention (e.g., FIG. 1) illustrate only four domains (powertrain domain, chassis domain, advanced driver assistance systems domain, and body domain), the present invention is not limited by the disclosed examples and may have any number or configuration of domains. Although examples of the present invention describe a plurality of domains, each including a plurality of ECUs, the present invention is not limited and may have a single domain including all the ECUs in the vehicle and/or multiple domains, some of which only include a single ECU. Further, although examples of the present invention includes using CAN messages, the present invention is not so limited and may use other low bandwidth communication protocols such as Local Interconnect Network (LIN) or Serial Peripheral Interfaces (SPI), etc.

FIG. 1 illustrates an exemplary system for secure communication in a vehicle network in accordance with some embodiments. A vehicle 100 can include a communications network that allows various ECUs to communicate with one another, with other devices in the vehicle, and with devices remote from the vehicle (e.g., across the internet). An ECU can be any embedded system that controls one or more of the electrical systems or subsystems in a vehicle such as an automobile. Examples of ECUs include an engine control module, a speed control unit, a powertrain control module, a transmission control module, a brake control module, and/or a door control unit, among numerous other possibilities. Each ECU can communicate data related to its operation. For example, a speed control unit could output a current speed, a door control unit could output a status indicating whether each door is opened, closed, locked, or unlocked, etc.

In some embodiments, the ECUs can be organized by function into a plurality of domains. For example, FIG. 1 illustrates a powertrain domain 104, a chassis domain 106, an advanced driver assistance systems (ADAS) domain 108, and a body domain 110. Each domain can include one or more ECUs and its own domain controller that can act as a firewall for any communication in or out of the domain. Further, the ECUs in various domains can be connected together via a center hub 102 that allows communicating with remote devices (e.g., via cell modem 114 that connects to cloud devices 112 over a network such as the internet).

Communication between ECUs can use controller area network (CAN) messages. This communication protocol is widely used and has a low overhead. However, CAN packets are traditionally limited to 8 bytes, and standard CAN tools cannot be used to debug and view CAN traffic. In some embodiments, the domain controller for each domain can be connected to the center hub 102 via Ethernet, and the domain controller can act as a gateway between in-domain communications on a CAN bus and communications outside the domain over Ethernet. By sending CAN messages over Ethernet, security protocols such as encryption and authentication can be more readily employed.

As illustrated in FIG. 1, different security levels can be used depending on the communication layer in the vehicle. In some embodiments, a high security level can be used for any communication that involves remote devices (e.g., any communication with the cloud 112 via a cell modem 114). A high security level can involve encrypting the transport layer (e.g., using transport layer security (TLS)) and/or authenticating the source of the communication (e.g., by verifying the media access control (MAC) address of the source of the communication). Further, in some examples, the content of the message can be authenticated by determining a message type of the communication and comparing it to a list of allowed message types. If the message type is included in the list, the message can be delivered, but if the message type is not included in the list, then the message can be dropped without being delivered.

In some embodiments, any messages between domains or between the center hub and an ECU may be communicated using a medium security level. The medium security level may include a subset of the security protocols used for the high security level. For example, any communication at the medium security level may be authenticated (e.g., by authenticating the MAC address and/or authenticating the message type) but it may not be encrypted. In some examples, the medium security level may involve some encryption that is faster and/or less secure than an encryption method used at the high security level. The encryption and/or authentication at any security level may be performed at the center hub and/or at a domain controller of a particular domain. Because communication at the medium and high security levels can be carried out using protocols such as Ethernet, standard authentication and encryption methods may be easily implemented to secure the communication.

In some embodiments, any messages between ECUs in the same domain may be communicated using a low security level. The low security level may include a subset of the security protocols used for the medium security level. In some examples, the low security level may not include any kind of encryption or authentication and may be carried out over a CAN bus without using Ethernet.

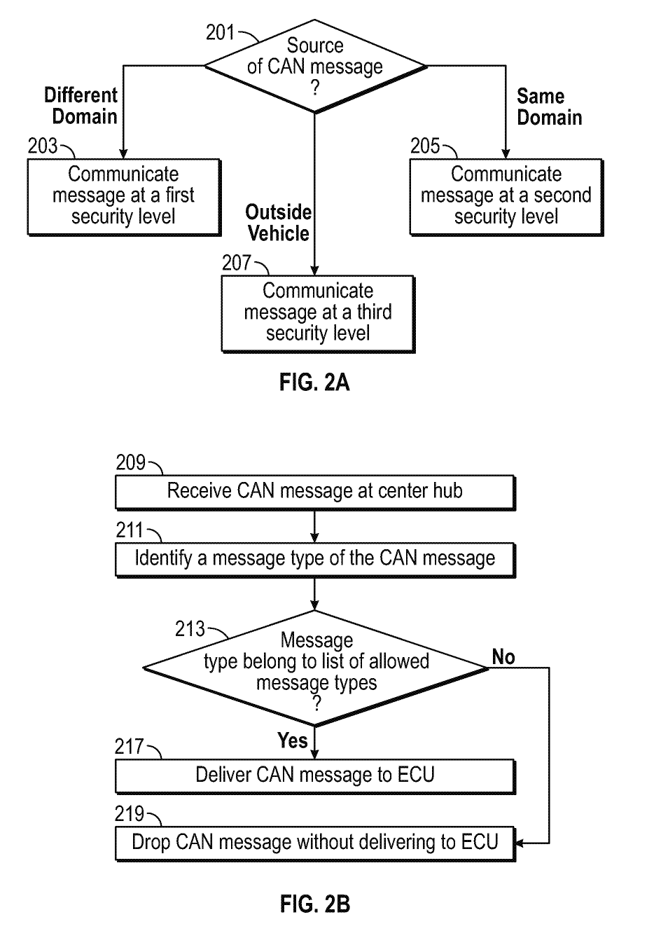

FIG. 2A illustrates an exemplary method of communicating between a center hub and a plurality of electronic control units in a vehicle in accordance with some embodiments. A CAN message may be communicated from a source to a first electronic control unit of the plurality of electronic control units. The security level can be determined based on the source of the CAN message (201). If the source of the CAN message is one of the plurality of electronic control units, the CAN message may be communicated to the first electronic control unit at a second security level (e.g., a low security level). For example, if the plurality of electronic control units belong to a first domain and the CAN message is sent within the first domain, then the CAN message may be communicated at a low security level (205). In some embodiment, in-domain communication may take place over a CAN bus (not Ethernet) that does not support security protocols such as authentication and encryption.

If the source of the CAN message is not one of the plurality of electronic control units, the CAN message may be communicated to the first electronic control unit at a first security level (e.g., medium security level). For example, if the source of the CAN message is an additional plurality of ECUs that belong to a second domain, different from the first, then the CAN message may be communicated at a medium security level (203). In some embodiments, the source of the CAN message may be outside the vehicle, and as a result the CAN message may be communicated at a third security level (e.g., a high security level) (207). In either case, security protocols such as encryption and/or authentication may be used because the communication uses a protocol such as Ethernet that supports those security methods. In some embodiments, communicating at relatively high security levels (e.g., at a medium or high security level as described herein) may include performing encryption/decryption and/or authentication at a domain controller or at a center hub as described above.

FIG. 2B illustrates a method of communicating between a center hub and a plurality of electronic control units in a vehicle. A CAN message may be received (209) at the center hub for delivery to a first electronic control unit of the plurality of electronic control units. A message type of the CAN message may be identified (211). The message may then be selectively delivered based on whether the message type belongs to a list of allowed message types (213). If the message type of the CAN message belongs to a list of allowed message types, the CAN message may be delivered (217) to the first electronic control unit. If the message type of the CAN message does not belong to the list of allowed messages types, the CAN message may be dropped (219) without being delivered to the first electronic control unit. For example, a list of allowed message types may include locking and unlocking doors, adjusting windows, etc., and disallowed message types may include applying brakes, accelerating, etc. In such an example, any message for accelerating would be dropped without being delivered.

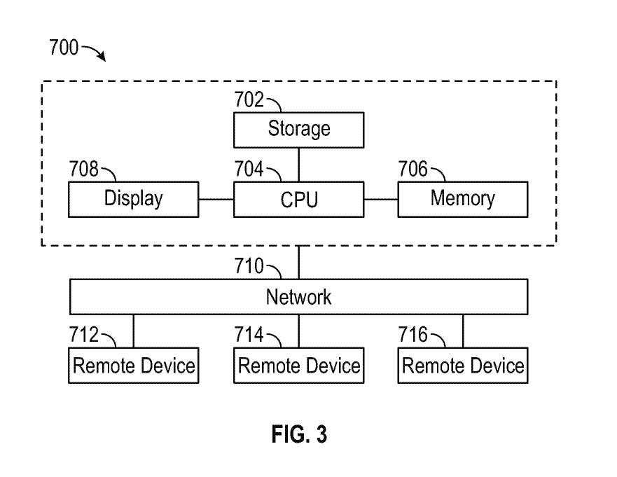

FIG. 3 illustrates an exemplary system 700 for secure communication in a vehicle network according to embodiments of the disclosure. The system 700 can include a CPU 704, storage 702, memory 706, and display 708. The CPU 704 can perform the methods illustrated in and described with reference to FIGS. 1-2B. Additionally, the storage 702 can store data and instructions for performing the methods illustrated and described with reference to FIGS. 1-2B. The storage can be any non-transitory computer readable storage medium, such as a solid-state drive or a hard disk drive, among other possibilities. User interfaces may be displayed on the display 708.

The system 700 can communicate with one or more remote devices 712, 714, and 716 over a wired or wireless network 710, such as a local area network, wide-area network, or internet, among other possibilities. The steps of the methods disclosed herein may be performed on a single system 700 or on several systems including the remote devices 712, 714, and 716.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. A vehicle comprising:
a center hub; and
a plurality of electronic control units connected to the center hub;
wherein the plurality of electronic control units are configured such that a first set of controller area network (CAN) messages are communicated at a first security level between the center hub and the plurality of electronic control units, and a second set of CAN messages are communicated at a second security level, lower than the first security level, among the plurality of electronic control units.

2. The vehicle of claim 1, wherein communicating the first set of CAN messages at the first security level includes authenticating a source of each respective CAN message of the first set of CAN messages, and communicating the second set of CAN messages at the second security level does not include authenticating a source of each respective CAN message of the second set of CAN messages.

3. The vehicle of claim 2, wherein authenticating the source of each respective CAN message of the first set of CAN messages includes authenticating a media access control (MAC) address of the source.

4. The vehicle of claim 1, wherein communicating the first set of CAN messages at the first security level includes comparing a message type of each respective CAN message of the first set of CAN messages to a list of allowed message types, and communicating the second set of CAN messages at the second security level does not include comparing a message type of each respective CAN message of the second set of CAN messages to the list of allowed message types.

5. The vehicle of claim 1, wherein the center hub is configured such that a third set of CAN messages are communicated at a third security level, higher than the first security level, between the center hub and one or more remote devices connected to the center hub across a network.

6. The vehicle of claim 5, wherein communicating the third set of CAN messages at the third security level includes encrypting the third set of CAN messages, and communicating the first set of CAN messages at the first security level does not include encrypting the first set of CAN messages.

7. The vehicle of claim 1, wherein the vehicle further comprises:
a plurality of domains, each comprising a CAN bus and a domain controller that interfaces between the CAN bus and the center hub.

8. The vehicle of claim 7, wherein each domain controller interfaces with the center hub via Eithernet.

9. The vehicle of claim 7, wherein the plurality of electronic control units all belong to a first domain of the plurality of domains, and the plurality of electronic control units are connected to each other via a respective CAN bus of the first domain.

10. A method of communicating between a center hub and a plurality of electronic control units in a vehicle, the method comprising:
communicating a controller area network (CAN) message from a source to a first electronic control unit of the plurality of electronic control units;
wherein:
in accordance with the source of the CAN message not being one of the plurality of electronic control units, the CAN message is communicated to the first electronic control unit at a first security level; and
in accordance with the source of the CAN message being one of the plurality of electronic control units, the CAN message is communicated to the first electronic control unit at a second security level, lower than the first security level.

11. The method of claim 10, wherein, in accordance with the source of the CAN message being outside the vehicle, the CAN message is communicated to the first electronic control unit at a third security level, higher than the first security level.

12. The method of claim 10, wherein:
the plurality of electronic control units belong to a first domain and an additional plurality of electronic control units belong to a second domain, different from the first domain;
the CAN message is communicated to the first electronic control unit at the first security level further in accordance with the source of the CAN message being one of the additional plurality of electronic control units belonging to the second domain; and
the CAN message is communicated to the first electronic control unit at the second security level further in accordance with the source of the CAN message being one of the plurality of electronic control units belonging to the first domain.

13. A non-transitory computer readable storage medium storing instructions that, when executed by one or more processors, cause the processors to perform a method of communicating between a center hub and a plurality of electronic control units in a vehicle, the method comprising:
communicating a controller area network (CAN) message from a source to a first electronic control unit of the plurality of electronic control units;
wherein:
in accordance with the source of the CAN message not being one of the plurality of electronic control units, the CAN message is communicated to the first electronic control unit at a first security level; and
in accordance with the source of the CAN message being one of the plurality of electronic control units, the CAN message is communicated to the first electronic control unit at a second security level, lower than the first security level.

14. A non-transitory computer readable storage medium storing instructions that, when executed by one or more processors, cause the processors to perform a method of communicating between a center hub and a plurality of electronic control units in a vehicle, the method comprising:
receiving a controller area network (CAN) message at the center hub for delivery to a first electronic control unit of the plurality of electronic control units;
identifying a message type of the CAN message;
in accordance with the message type of the CAN message belonging to a list of allowed message types, delivering the CAN message to the first electronic control unit; and
in accordance with the message type of the CAN message not belonging to the list of allowed messages types, dropping the CAN message without delivering to the first electronic control unit.

15. A system comprising:
one or more processors; and
a memory;
wherein the one or more processors are configures to perform a method of communicating between a center hub and a plurality of electronic control units in a vehicle, the method comprising:
communicating a controller area network (CAN) message from a source to a first electronic control unit of the plurality of electronic control units;
wherein:
in accordance with the source of the CAN message not being one of the plurality of electronic control units, the CAN message is communicated to the first electronic control unit at a first security level; and
in accordance with the source of the CAN message being one of the plurality of electronic control units, the CAN message is communicated to the first electronic control unit at a second security level, lower than the first security level.

16. A system comprising:
one or more processors; and
a memory;
wherein the one or more processors are configured to perform a method of communicating between a center hub and a plurality of electronic control units in a vehicle, the method comprising:
receiving a controller area network (CAN) message at the center hub for delivery to a first electronic control unit of the plurality of electronic control units;
identifying a message type of the CAN message;
in accordance with the message type of the CAN message belonging to a list of allowed message types, delivering the CAN message to the first electronic control unit; and
in accordance with the message type of the CAN message not belonging to the list of allowed messages types, dropping the CAN message without delivering to the first electronic control unit.
